(19) United States
(12) Patent Application Publication
(10) Pub. No.: US 2023/0385838 A1
(43) Pub. Date: Nov. 30, 2023

(54) COMPUTERIZED-METHOD AND DATA-ANALYSIS SYSTEM FOR ANALYZING FINANCIAL DATA TO IMPROVE PERFORMANCE OF A CONCEPT DRIFT DETECTOR THAT IS PROVIDING ALERTS OF DRIFT TO AN UPDATE COMPONENT OF A MACHINE LEARNING MODEL FOR FRAUD PREDICTION AND DETECTION

(71) Applicant: Actimize LTD., Ra'anana (IL)

(72) Inventors: Danny BUTVINIK, Haifa (IL); Yoav AVNEON, Ness-Ziyona (IL)

(21) Appl. No.: 17/827,835

(22) Filed: May 30, 2022

(51) Int. Cl. G06Q 20/40

(52) U.S. Cl. CPC G06Q 20/4016; G06N 20/00

(57) ABSTRACT

A computerized-method for analyzing financial data to improve performance of a concept-drift-detector that is providing alerts of drift to an update component of a machine learning model for fraud prediction and detection, is provided herein. The computerized-method includes retrieving a time-series data of financial transactions having one or more features, during a time unit. For each feature, detecting a process of values of the feature to determine a type of the process. When the type of the process of a feature is determined as nonstationary, determining a subtype thereof and if the process is feasible for rectification to a stationary process, rectifying it. When the type of the process is determined as stationary, determining its subtype and when the type of the process is determined as nonstationary and the process is not feasible for rectification, forwarding the time-series data, the type of the process and the subtype to the concept-drift-detector.

### TECHNICAL FIELD

The present disclosure relates to the field of machine learning, statistics and advanced data analysis.

### BACKGROUND

Machine learning (ML) is the study of computer algorithms that can improve automatically through experience and by the use of data and it is seen as a part of artificial intelligence. ML algorithms build a model based on sample data, known as training data, in order to make predictions or decisions without being explicitly programmed to do so. For example, supervised ML model in fraud detection trains on the data that is already known, which transactions are labeled as legit or as fraud, and then operates on unknown data to predict its label. ML models are used in predictive and prescriptive analytics for detection, prediction, and recognition. It is used to detect fraudulent or anomalous patterns in the data, predict about future trend/behavior, evaluate a risk or likelihood for a particular transaction be a fraud, and is able to recognize trends within complex patterns.

A subset of ML is closely related to computational statistics, which focuses on making predictions using computers; but not all machine learning is statistical learning. The study of mathematical optimization delivers methods, theory and application domains to the field of ML. Data mining is a related field of study, focusing on exploratory data analysis through unsupervised learning. Some implementations of ML use data and neural networks in a way that mimics the working of a biological brain.

ML is a method of data analysis that automates analytical model building. It is a branch of artificial intelligence based on the idea that systems can learn from data, identify patterns and make decisions with minimal human intervention.

Advanced analytics is a data analysis methodology that uses predictive modeling, ML algorithms, deep learning, business process automation and other statistical methods to analyze business information. Data analytics, explorative, diagnostic, predictive and prescriptive, is the process of exploring the data from the past to make appropriate decisions in the future by using valuable insights.

Every ML system suffers from gradual degradation in performance over time. The main reason for that phenomenon is concept drift. In predictive analytics and ML domain, concept drift means that the statistical properties of a target variable, which the ML model is trying to predict, change over time in unforeseen ways. This causes problems because the predictions become less accurate as time passes.

In other words, concept drift is a change in statistics of the data or shift in its distribution, also known as distribution shift. Changes in financial data is very common due to exposure to a mass of events that have both global and local impact, such as geopolitics, micro and macroeconomics, socioeconomics, war, natural disasters, climate change, pandemics and other. These events affect the financial data flow almost immediately and a domino effect may start.

For example, fraudsters change their behavioral patterns, trends and pattern with a complex set of financial datum starts to evolve, markets dictate different conditions and the like. All these events directly influence the performance of ML models. A typical ML system is based on model training that happens on historical data to later on perform predictions as to data. If current data has different inherent statistics, then the ML model cannot cope to perform accurate predictions with it because it has knowledge that has been gained on old data.

To overcome this acute problem, in current technical solutions there are concept drift detectors, which are algorithms that aim to identify drift in the data, as soon as possible, and operate to send an alert about the drift to the ML model via an update component. The notification may include the start time and the end time of the drift. Once an update component receives such alert, it sends a notification to the ML model to update itself and adjust to new data. The ML model may passively update itself. There are many methods and approaches on how a ML model may update itself.

The concept drift detector may be explicit, meaning applying a supervised detection technique or implicit which is applying unsupervised detection technique.

However, in current solutions most of the concept drift detectors are inefficient on their task because they lack deep insights about the data the concept drift detectors work on. Once a concept drift detector performs well, the ML model may update itself in a much more effective way, which may result in a better performance of ML model on data with concept drift.

Accordingly, there is a need for a technical solution to improve a concept drift detector performance so that it may provide alerts of drift to the ML model via an update component.

Furthermore, there is a need for a system and method for analyzing financial data to improve performance of a concept drift detector that is providing alerts of drift to an update component of a machine learning model for fraud prediction and detection.

### SUMMARY

There is thus provided, in accordance with some embodiments of the present disclosure, a computerized-method for analyzing financial data to improve performance of a concept drift detector that is providing alerts of drift to an update component of a machine learning model for fraud prediction and detection.

In accordance with some embodiments of the present disclosure, the computerized-method includes retrieving a time-series data of financial transactions having one or more features, during a time unit from a time-series financial transactions database.

Furthermore, in accordance with some embodiments of the present disclosure, for each feature of the one or more features, the computerized-method may include detecting a process of values of the feature during the time unit to determine a type of the process.

Furthermore, in accordance with some embodiments of the present disclosure, when the process is feasible for rectification, the computerized-method may include operating a rectification module to: (i) rectify the nonstationary process to a stationary process, and (ii) determine the process as stationary.

Furthermore, in accordance with some embodiments of the present disclosure, when the type of the process is determined as stationary, the computerized-method may include determining a subtype thereof and when the type of the process is nonstationary and the process is not feasible for rectification or when the type of the process is determined as stationary, then, the computerized-method may include forwarding the retrieved time-series data of financial transactions, the type of the process and the determined subtype to the concept drift detector and an identification of start time and end time of a drift during the time unit.

Furthermore, in accordance with some embodiments of the present disclosure, the concept drift detector may analyze the time-series data of financial transactions, the type of the process and the determined subtype to detect a drift therein and when a drift is detected the concept drift detector may send a drift-alert to an update component of the machine learning model, thereby improving machine learning model updates of itself according to the drift-alert, increasing accuracy of fraud predictions of the machine learning model and providing a memory efficient method.

Furthermore, in accordance with some embodiments of the present disclosure, the detecting of the process of values of the feature during the time unit to determine the type of the process as stationary may be performed by a first-test and the detecting of the process of values of the feature during the time unit to determine the type of the process the process as nonstationary may be performed by a second-test.

Furthermore, in accordance with some embodiments of the present disclosure, the first-test may be selected from at least one of: (i) Kwiatkowski-Phillips-Schmidt-Shin (KPSS); (ii) other tests, and wherein the second-test may be selected from at least one of: (i) Augmented Dickey Fuller (ADF); (ii) other tests.

Furthermore, in accordance with some embodiments of the present disclosure, a stationary type of process may be determined from at least one of: (i) strict stationary; (ii) 1st order stationary; (iii) 2nd order stationary.

Furthermore, in accordance with some embodiments of the present disclosure, a nonstationary type of process may be determined from at least one of: (i) deterministic trend; (ii) random walk; and (iii) stochastic deterministic trend.

Furthermore, in accordance with some embodiments of the present disclosure, the machine learning model may be supervised or unsupervised.

Furthermore, in accordance with some embodiments of the present disclosure, a drift-alert to the update component of the machine learning model may include start time and end time of the drift, type and subtype of the process.

Furthermore, in accordance with some embodiments of the present disclosure, the concept drift detector may be using one or more preconfigured algorithms.

Furthermore, in accordance with some embodiments of the present disclosure, the type of the process may be determined as stationary when a process of values of the feature during the time unit has a constant mean or having an amplitude that neither increases nor decreases across the time-series data of the financial transactions.

Furthermore, in accordance with some embodiments of the present disclosure, the type of the process may be determined as nonstationary when a process of values of the feature during the time unit hasn't a constant mean or having an amplitude that neither increases nor decreases across the time-series data of financial transactions.

Furthermore, in accordance with some embodiments of the present disclosure, a subtype of a stationary process may be determined as: (i) strict stationary when all statistic parameters are constant; (ii) 1^{st} order stationary when a calculated mean of the values of the feature during the time unit is constant and other statistic parameters vary; (iii) 2^{nd} order stationary when a calculated mean of the values of the feature during the time unit is constant, variance and autocovariance constant and all other statistic parameters vary.

Furthermore, in accordance with some embodiments of the present disclosure, the identification of start time and end time of a drift during the time unit may identified by a concept drift detection algorithm.

There is further provided, in accordance with some embodiments of the present disclosure, a data-analysis system for analyzing financial data to improve performance of a concept drift detector that is providing alerts of drift to an update component of a machine learning model for fraud prediction.

Furthermore, in accordance with some embodiments of the present disclosure, the data-analysis system includes a time-series financial transactions database; a memory to store the time-series financial transactions database, and one or more processors.

Furthermore, in accordance with some embodiments of the present disclosure, the one or more processors may be configured to: (i) retrieve a time-series data of financial transactions having one or more features, during a time unit from a time-series financial transactions database; (ii) for each feature of the one or more features, detect a process of values of the feature during the time unit to determine a type of the process; (iii) when the type of the process of a feature of the one or more features is determined as nonstationary, determine a subtype thereof and checking if the process is feasible for rectification to a stationary process; (iv) when the process is feasible for rectification, operate a rectification module to: rectify the nonstationary process to a stationary process, and determine the process as stationary; (v) when the type of the process is determined as stationary, determine a subtype thereof, (vi) and when the type of the process is nonstationary and is not feasible for rectification or when the type of the process is determined as stationary, then, forward the retrieved time-series data of financial transactions, the type of the process and the determined subtype to the concept drift detector and an identification of start time and end time of a drift during the time unit.

Furthermore, in accordance with some embodiments of the present disclosure, the concept drift detector may analyze the time-series data of financial transactions, the type of the process and the determined subtype to detect a drift therein and when a drift is detected the concept drift detector may send a drift-alert to an update component of the machine learning model, thereby improving updates of the machine learning model according to the drift-alert, increasing accuracy of fraud predictions of the machine learning model and providing a memory efficient method.

### BRIEF DESCRIPTION OF THE DRAWINGS

In order for the present disclosure, to be better understood and for its practical applications to be appreciated, the following Figures are provided and referenced hereafter. It should be noted that the Figures are given as examples only and in no way limit the scope of the disclosure. Like components are denoted by like reference numerals.

FIG. 1 schematically illustrates a high-level diagram of a computerized-system for analyzing financial data to improve performance of a concept drift detector that is providing alerts of drift to an update component of a machine learning model for fraud prediction and detection, in accordance with some embodiments of the present disclosure;

FIGS. 2A-2B a schematic flowchart of a computerized-method for analyzing financial data to improve performance of a concept drift detector that is providing alerts of drift to an update component of a machine learning model for fraud prediction and detection, in accordance with some embodiments of the present disclosure;

FIG. 3 is a high-level end to end of data, in accordance with some embodiments of the present disclosure;

FIG. 4 is a high-level workflow in a data analysis unit, in accordance with some embodiments of the present disclosure;

FIG. 5 is a high-level workflow of nonstationary subtype identification, in accordance with some embodiments of the present disclosure;

FIG. 6 is a graph showing the accuracy of concept drift detector dependent on process type, in accordance with some embodiments of the present disclosure;

FIGS. 7A-7B show graphs of stationary and nonstationary processes;

FIG. 8 shows a table of evaluation results and comparisons, in accordance with some embodiments of the present disclosure; and

FIG. 9 is a high-level process flow diagram, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

One of the major problems in fraud detection is addressing a phenomenon of concept drift in financial data. The financial data includes financial transactions having one or more features. The financial crime domain is a dynamic environment that is affected by multitudinous factors both in global and local scales, such as geopolitics, micro and macro economy, economic crises, wars, natural disaster, and pandemics. All these critical events may impose an immediate influence on the behavior of financial trends, fraudulent patterns, statistics and many more. The results of these factors, which influence the financial crime domain, on each feature of one or more features of financial transactions over time, are named concept drift.

Concept drift means that there is a change in the statistics, e.g., mean and variance, of one of the features of the financial data or in its distribution over time. An impact of critical events may have different shapes such as: cyclic, monotonic, seasonal etc. The occurrence of such events may have impact on the performance and the accuracy of fraud predictions of the Machine Learning (ML) models that detect fraud. In the majority of cases in production environment operate ML models which were trained on historical data to predict future events.

However, if current financial data behaves differently than the historic data that the ML learning models have been trained on, i.e., its statistics are different, then the ML model may fail coping with these changes and provide inaccurate predictions, which may practically translate into false-positive predictions that may later on unnecessarily consume investigation resources or false-negative which means that a fraud is not detected.

To overcome the acute problem of concept drift, there are currently numerous algorithms for concept drift detection which are operated by a concept drift detector. The concept drift detector is using the algorithms to identify drift in received data before the financial transactions are forwarded to the ML model for fraud prediction.

Once the concept drift detector identifies a drift in the data, e.g., change in statistics, it sends an alert to an update component of the ML model which indicates the ML model that there is a drift in the data. Accordingly, the ML model updates itself based on a configured technique which has been selected out of existing techniques.

However, currently most of concept drift detectors are inefficient on their task because they lack deep insights about the data the concept drift detectors work on and only the start time and end time of the drift are provided. Hence, the alerts which are sent by the concept drift detector to the update component may result with poor performance of the ML model, i.e., inaccurate predictions.

For example, when the concept drift detector is inefficient, the ML model may update itself when there is no need, and thus waste computing resources, in another example the ML model may update itself not efficiently i.e., not enough and may fail capturing the drift in the data, in yet another example, the ML model may update itself too early e.g., before the drift or too late, e.g., after the drift.

A time series is a sequence of data points, e.g., financial transactions, that occur in a successive order over time. The process of values of a feature of financial transactions over time may be nonstationary or have means, variances, and covariances that change over time. Nonstationary behaviors can be trends, stochastic, random walks. A concept drift detector which may receive such nonstationary time series during a time unit without an indication as to the nonstationary data and its subtype, may incorrectly indicate a relationship between two variables where one does not exist.

Therefore, in order to receive consistent and reliable results, the nonstationary time series has to be initially rectified or transformed into stationary data which has a constant mean and has a constant variance independent of time or indicated to the concept drift detector.

A concept drift detector may work better, that is, send more accurate alerts to the update component of the ML model, when it may be provided a deep analysis and advanced insights, e.g., when it may receive the nature of the drift, such as if the process of each feature value over time is a stationary or nonstationary process and the process subtype.

Thus, by elevating the performance of the concept drift detector to send more accurate alerts to the update component of the ML model, the ML model may update itself in a much more effective way which will result in a better performance of the ML model on data with concept drift.

Accordingly, there is a need for a technical solution for improving performance of a concept drift detector providing alerts of drift to an update component of a machine learning model for prediction. Furthermore, there is a need for advanced data-analysis system and computerized-method for analyzing financial data to improve performance of a concept drift detector that is providing alerts of drift to an update component of a machine learning model for fraud prediction.

The term “data analysis” as used herein refers to advanced data analytics which is a methodology that uses predictive modeling, machine learning algorithms, deep learning, business process automation and other statistical methods to analyze business information, such as time-series financial transactions.

The term “difference stationary” as used herein refers to a product of nonstationary process rectification to a stationary process and may have a subtype from at least one of: (i) strict stationary; (ii) 1^{st} order stationary; (iii) 2^{nd} order stationary. For simplicity, it may be referred to as stationary.

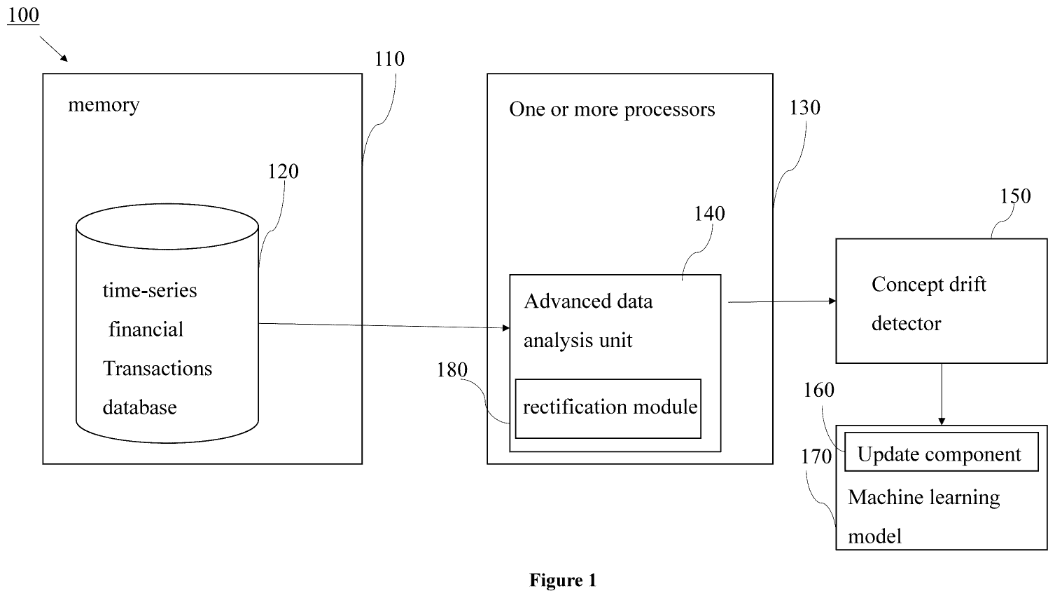

FIG. 1 schematically illustrates a high-level diagram of a computerized-system 100 for analyzing financial data to improve performance of a concept drift detector that is providing alerts of drift to an update component of a Machine Learning (ML) model for fraud prediction and detection, in accordance with some embodiments of the present disclosure.

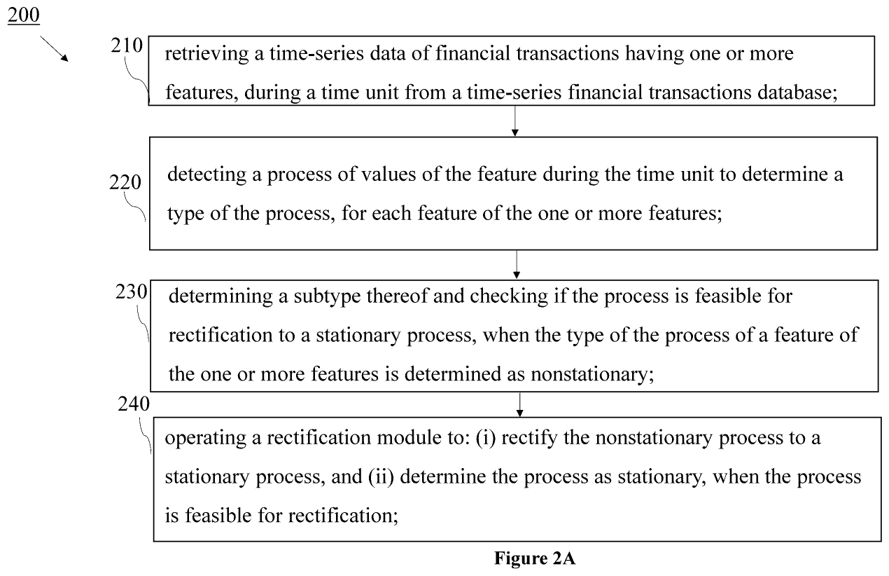

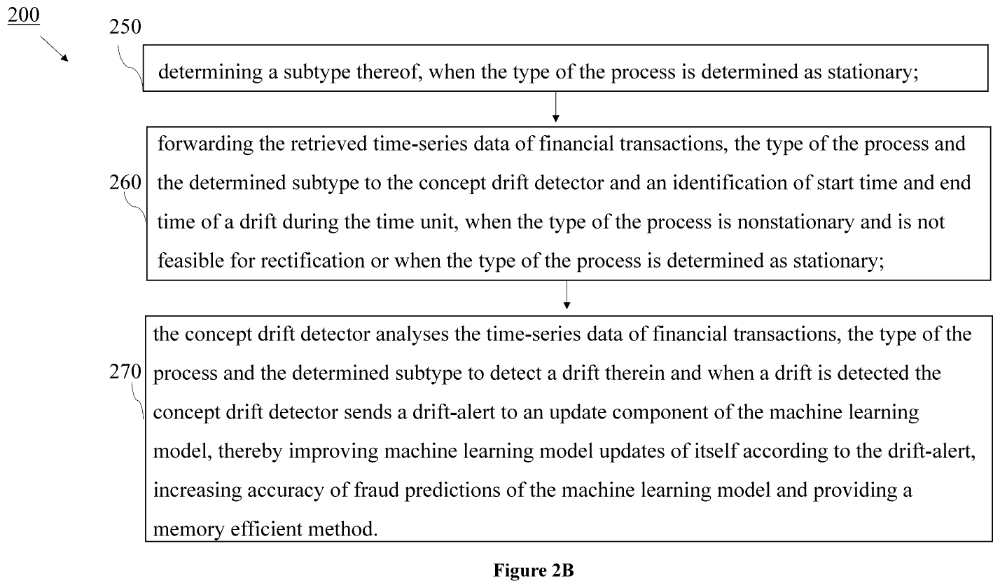

According to some embodiments of the present disclosure, in a system, such as computerized-system 100, one or more processors 130 may operate an advanced data analysis unit 140. The advanced data analysis unit 140 may operate a computerized-method, such as computerized-method 200 in FIGS. 2A-2B which may include retrieving a time-series data of financial transactions having one or more features, during a time unit from a database, such as time-series financial transactions database 120. The one or more features may be for example, amount of money being transferred; time of transaction; day of the week and the like.

According to some embodiments of the present disclosure, the time-series financial transactions database 120 may be stored in memory 110.

According to some embodiments of the present disclosure, the advanced data analysis unit 140 may further operate the computerized-method, such as computerized-method 200 in FIGS. 2A-2B which may include detecting a process of values of each feature of the one or more features during the time unit to determine a type of process of the retrieved time-series data of financial transactions.

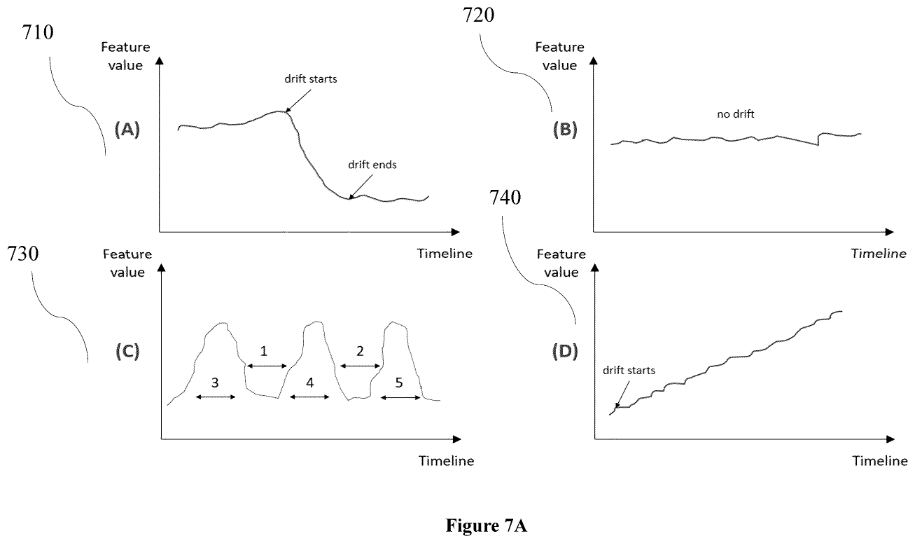

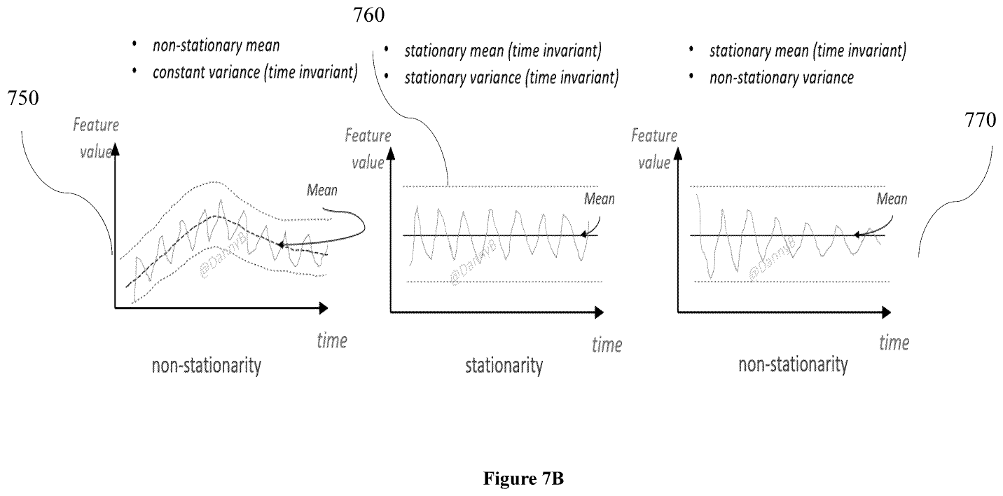

According to some embodiments of the present disclosure, the process type may be stationary or nonstationary, as shown for example, in graphs 750-770 in FIG. 7B. When the type of the process of a feature of the one or more features of the financial transactions is determined as nonstationary, the computerized-method may further include determining a subtype of the process and checking if the process is feasible for rectification to a stationary process.

According to some embodiments of the present disclosure, when the process is feasible for rectification, the computerized-method may include operating a rectification module 180 to rectify the nonstationary process to a stationary process and determine the process as difference stationary. The difference stationary process may have a subtype that may be selected from at least one of: (i) strict stationary; (ii) 1^{st} order stationary; (iii) 2^{nd} order stationary.

Rectification module 180 may be operated by performing a differencing between two adjusted transactions or points. Sometimes, it does not have to be adjacent transaction, but skipping ‘1’. E.g. 1, 3, 5, 7 and so on.

Any concept drift detector can work on stationary data knowing the subtype of stationary process, multiple times better than without knowing that information.

According to some embodiments of the present disclosure, when the type of the process is determined as stationary, the computerized-method may further include determining a subtype of the stationary process. A stationary type of process may be determined from at least one of: (i) strict stationary; (ii) 1^{st} order stationary; (iii) 2^{nd} order stationary; (iv) trend stationary; and (v) difference stationary.

According to some embodiments of the present disclosure, when the type of the process is determined as nonstationary and the process is not feasible for rectification or when the type of the process is determined as stationary, then, the computerized-method may further include forwarding the retrieved time-series data of financial transactions, the type of the process and the determined subtype and an identification of start time and end time of a drift during the time unit to a concept drift detector 150.

According to some embodiments of the present disclosure, the concept drift detector 150 may analyse the time-series data of financial transactions, the type of the process and the determined subtype to detect a drift therein and when a drift may be detected the concept drift detector 150 may send a drift-alert to an update component 160 of the machine learning model 170, thereby improving machine learning model updates of itself according to the drift-alert, increasing accuracy of fraud predictions of the machine learning model and providing a memory efficient method.

According to some embodiments of the present disclosure, the detecting of the process of values of the feature during the time unit to determine the type of the process as stationary may be performed by a first-test and the detecting of the process of values of the feature during the time unit to determine the type of the process the process as nonstationary may be performed by a second-test. The first-test may be selected from at least one of: (i) Kwiatkowski-Phillips-Schmidt-Shin (KPSS); (ii) other tests, and wherein the second-test may be selected from at least one of: (i) Augmented Dickey Fuller (ADF); (ii) other tests.

According to some embodiments of the present disclosure, a nonstationary type of process of values of the feature during the time unit may be determined from at least one of: (i) deterministic trend; (ii) random walk; (iii) stochastic deterministic trend.

According to some embodiments of the present disclosure, the machine learning model 170 may be supervised or unsupervised. The concept drift detector 150 may be implicit which is an unsupervised detection or explicit which is a supervised detection.

According to some embodiments of the present disclosure, a drift-alert to the update component 160 of the machine learning model 170 may include start time and end time of the drift, type and subtype of the process.

According to some embodiments of the present disclosure, the type of the process may be determined as stationary when a process of values of the feature during the time unit has a constant mean or having an amplitude that neither increases nor decreases across the time-series data of the financial transactions during the time unit, as shown in graph 760 in FIG. 7B.

According to some embodiments of the present disclosure, the type of the process may be determined as nonstationary when a process of values of the feature during the time unit hasn't a constant mean, as shown in graph 750 in FIG. 7B or having an amplitude that neither increases nor decreases across the time-series data of financial transactions, as shown in graph 770 in FIG. 7B.

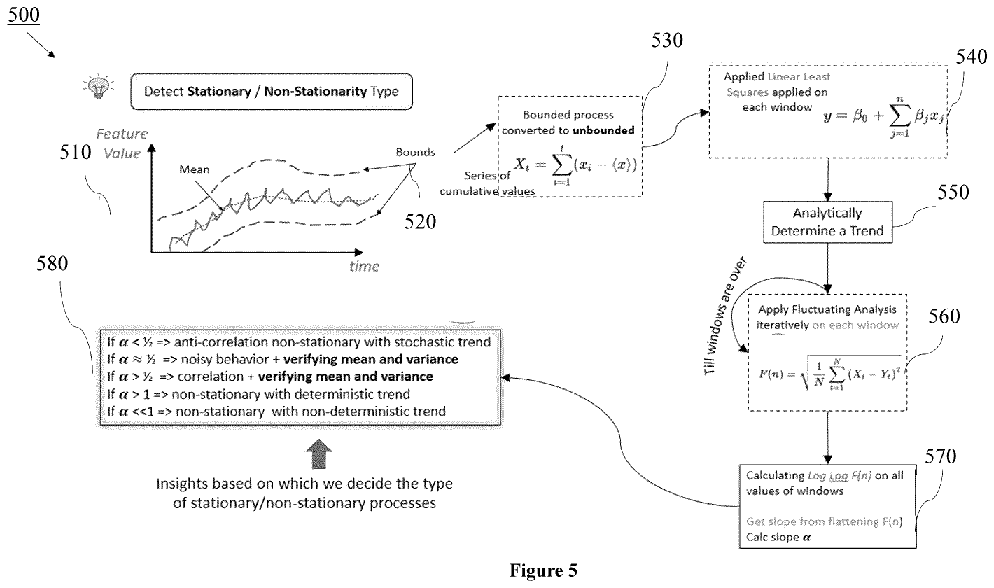

According to some embodiments of the present disclosure, a subtype of the nonstationary process may be determined, as shown in the high-level workflow of nonstationary subtype identification 500 in FIG. 5.

According to some embodiments of the present disclosure, a subtype of a stationary process of a feature may be determined as: (i) strict stationary when all statistic parameters are constant; (ii) 1^{st} order stationary when a calculated mean of the values of the feature during the time unit is constant and other statistic parameters vary; (iii) 2^{nd} order stationary when a calculated mean of the values of the feature during the time unit is constant, variance and autocovariance constant and all other statistic parameters vary.

According to some embodiments of the present disclosure, the identification of start time and end time of a drift during the time unit may be identified by a concept drift detection algorithm. For example, drift started at 12:03:21; drift ended at 12:03:23.

According to some embodiments of the present disclosure, the advanced data analysis unit 140 may provide a performance improvement of the concept drift detector 150 that is providing alerts of drift to the update component 160 of the machine learning model 170 for fraud prediction and detection, thus improving the machine learning model updates of itself according to the drift-alert and saving computer resources which might have been invested in redundant updates of the ML model 170.

When the ML model does not have an update mechanism and/or concept drift detector, then to adapt the ML model to changes in the data can be only through retraining the ML model, which is equivalent to building a ML model from the scratch including the following stages: data preprocessing, feature engineering, training, validation, test, and optimization. Meaning, building the ML model from scratch may require a lot of effort and it is a time-consuming procedure. Moreover, during the time that the ML model is rebuilt or retraining the financial system may be exposed to fraud since there will be no ML model operating for fraud predictions.

According to some embodiments of the present disclosure, the advanced data analysis unit 140 may further increase the accuracy of fraud predictions of the machine learning model by improving the drift-alerts which are sent to the update component 160 of the ML model 170.

FIGS. 2A-2B a schematic flowchart of a computerized-method for analyzing financial data to improve performance of a concept drift detector that is providing alerts of drift to an update component of a machine learning model for fraud prediction and detection, in accordance with some embodiments of the present disclosure.

According to some embodiments of the present disclosure, operation 210 may comprise retrieving a time-series data of financial transactions having one or more features, during a time unit from a time-series financial transactions database.

According to some embodiments of the present disclosure, operation 220 may comprise, detecting a process of values of the feature during the time unit to determine a type of the process for each feature of the one or more features.

According to some embodiments of the present disclosure, operation 230 may comprise determining a subtype thereof and checking if the process is feasible for rectification to a stationary process, when the type of the process of a feature of the one or more features is determined as nonstationary.

According to some embodiments of the present disclosure, operation 240 may comprise operating a rectification module to: (i) rectify the nonstationary process to a stationary process, and (ii) determine the process as stationary, when the process is feasible for rectification.

According to some embodiments of the present disclosure, operation 250 may comprise determining a subtype thereof, when the type of the process is determined as stationary.

According to some embodiments of the present disclosure, operation 260 may comprise forwarding the retrieved time-series data of financial transactions, the type of the process and the determined subtype to the concept drift detector and an identification of start time and end time of a drift during the time unit, when the type of the process is nonstationary and is not feasible for rectification or when the type of the process is determined as stationary.

According to some embodiments of the present disclosure, operation 270 may comprise the concept drift detector analyses the time-series data of financial transactions, the type of the process and the determined subtype to detect a drift therein and when a drift is detected the concept drift detector sends a drift-alert to an update component of the machine learning model, thereby improving machine learning model updates of itself according to the drift-alert, increasing accuracy of fraud predictions of the machine learning model and providing a memory efficient method.

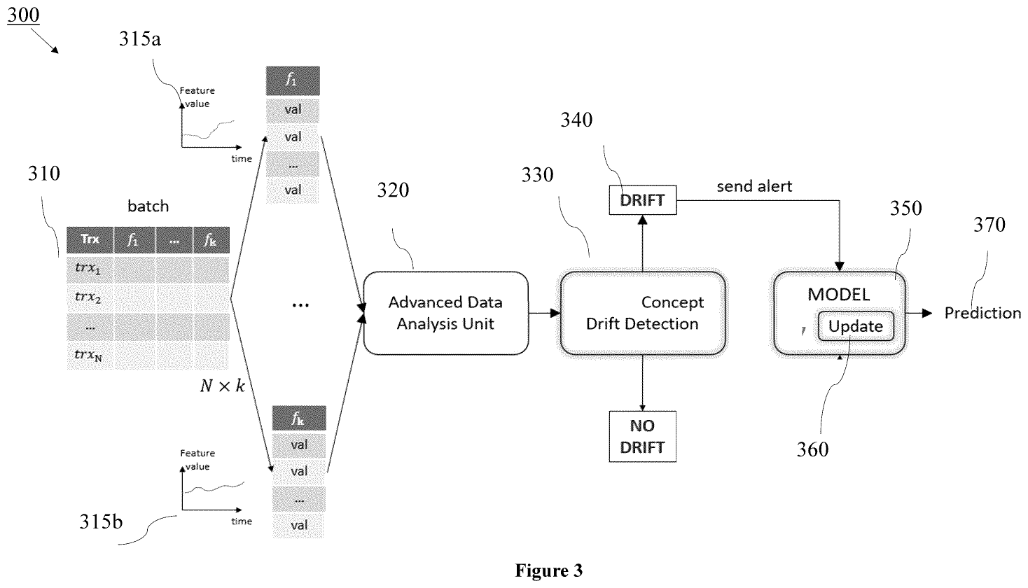

FIG. 3 is a high-level end to end of data, in accordance with some embodiments of the present disclosure.

According to some embodiments of the present disclosure, a time-series data of financial transactions having one or more features, during a time unit 310 may be retrieved from a time-series financial transactions database. The time-series data of financial transactions having one or more features, during a time unit 310 may be processed in an advanced data analysis unit 320, such as advanced data analysis unit 140 in FIG. 1.

According to some embodiments of the present disclosure, after each feature such as 315a and 315b of the one or more features of the time-series data of financial transactions has been analyzed, the insights based on the financial data may be forwarded a concept drift detector 330, such as concept drift detector 150 in FIG. 1.

According to some embodiments of the present disclosure, the concept drift detector 330 may analyze whether there is a drift in the time-series data of financial transactions having one or more features, during a time unit 310.

According to some embodiments of the present disclosure, when the concept drift detection 330 may detect a drift 340 then it may send a drift-alert to the ML model 350 via the update component 360, so that the ML model 350 may activate its build-in update mechanism 360. In case there is no drift, the concept drift detector 330 may not send a drift-alert to the ML model 350. The ML model 350 may provide a prediction for each financial transaction of the time-series data of financial transactions having one or more features, during a time unit 310, whether it is fraud or legit that is, not fraud.

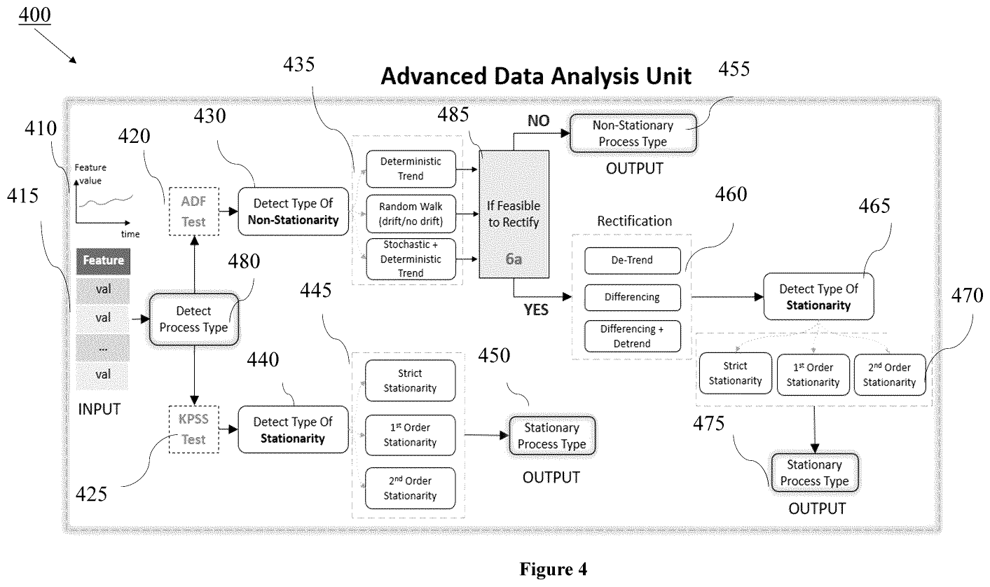

FIG. 4 is a high-level workflow in a data analysis unit 400, in accordance with some embodiments of the present disclosure.

According to some embodiments of the present disclosure, a data analysis unit 400, such as advanced data analysis 140 in FIG. 1, may be provided with a feature 415 of a time-series data of financial transactions having one or more features, during a time unit.

According to some embodiments of the present disclosure, a process of values of the feature over time is shown for example, in graph 410. A component of process type detection 480 may apply two tests on the time-series data of financial transactions having one or more features, to identify a type of the process. For example, Augmented Dickey Fuller (ADF) test 420 intends to reveal whether the process is nonstationary, and Kwiatkowski-Phillips-Schmidt-Shin (KPSS) test 425 intends to reveal whether the process is stationary.

According to some embodiments of the present disclosure, in case, a stationary process has been identified, then a component to detect subtype of stationary 440 may identify its subtype. The subtype may be as shown in element 445: (i) strict stationary; (ii) 1^{st} order stationary; (iii) 2^{nd} order stationary.

According to some embodiments of the present disclosure, the output of the component to detect subtype of stationary 440 may be the type of data process with the subtype, for example, process type: stationery and subtype: 1^{st} order.

According to some embodiments of the present disclosure, when the process type is nonstationary as detected by the ADF test 420, then a component to detect subtype of nonstationary process may be operated. The nonstationary subtype 435 may be determined from at least one of: (i) deterministic trend; (ii) random walk; (iii) stochastic deterministic trend.

According to some embodiments of the present disclosure, a component 485 may check if it is possible to rectify the nonstationary process. If the component 485 determines that the nonstationary is feasible for rectification, then a rectification module 460 may be operated to yield a stationary process. Then, the subtype of the stationary process may be detected by a detect type of stationary component 465 to yield a stationary process subtype 475.

According to some embodiments of the present disclosure, if the rectification is not possible, then the data analysis unit 400 may output the type of data process with its subtype 455. For example, process: non-stationary, type: random walk with drift. In case, rectification is feasible, then a rectification component 460 may perform the process of rectification according to the nonstationary subtype. For example, for deterministic trend it may operate de-trend procedure, for random walk process type it may operate differencing and for stochastic and deterministic trend it may operate differencing and de-trend.

According to some embodiments of the present disclosure, the rectification component 460 may output a stationary process since it rectified a non-stationary process. Then a component to detect type of stationary process 465 and such as 440 may be operated to output the type of the process and its subtype.

FIG. 5 is a high-level workflow of nonstationary subtype identification 500, in accordance with some embodiments of the present disclosure.

According to some embodiments of the present disclosure, the following workflow 500 may be applied to identify a subtype of nonstationary process. A component, such as detect process type 480 in FIG. 4 has detected a nonstationary process type for a time-series data of financial transactions having one or more features, during a time unit, as shown for example in graph 510. The time-series data may have for example, bounds 520. The bounded process 520 may be converted to unbound process, as shown in element 530.

According to some embodiments of the present disclosure, linear least squares may be applied on each window 540. For example, a window may be period in time, or number of data points or transactions for example, window of 2 on series of 1, 2, 3, 4, 5, 6, 7, 8, 9, would be (1,2), (3,4), (5,6) to analytically determine a trend 550.

According to some embodiments of the present disclosure, fluctuating analysis may be iteratively applied on each window until all windows are over. As shown in element 560.

According to some embodiments of the present disclosure, Log Log F(n) may be calculated on all values of windows 570 and then getting slop a from flattening F(n). The subtype of the nonstationary process may be determined based on the value of a, as shown by element 580.

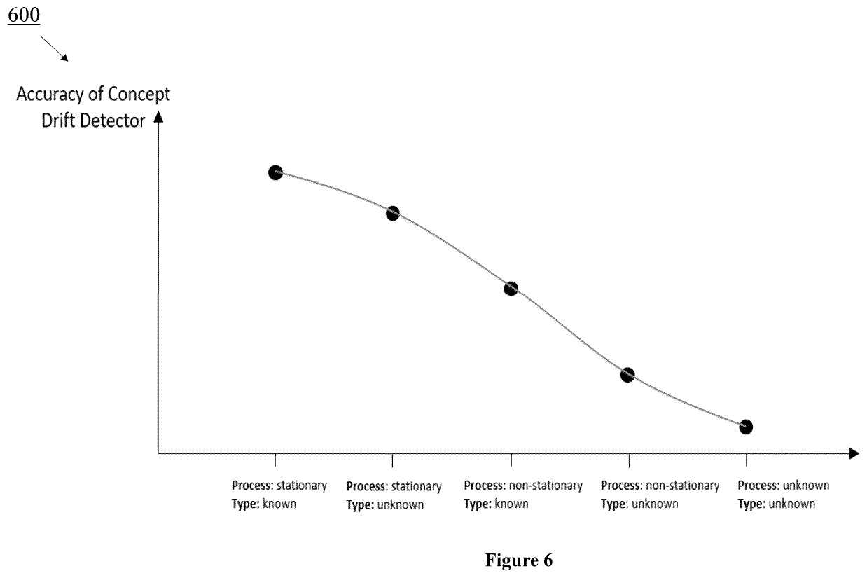

FIG. 6 is a graph showing the accuracy of concept drift detector dependent on process type 600, in accordance with some embodiments of the present disclosure.

According to some embodiments of the present disclosure, a concept drift detector, such as concept drift detector 150 in FIG. 1 and concept drift detection 330 in FIG. 3, may perform better, that is, may provide the most accurate drift-alerts when the process of values of a feature during the time unit is stationary and the subtype is known.

According to some embodiments of the present disclosure, the performance of the concept drift detector, such as concept drift detector 150 in FIG. 1 and concept drift detection 330 in FIG. 3, may decrease when the process of values of a feature during the time unit is stationary and the subtype is unknown.

According to some embodiments of the present disclosure, the performance of the concept drift detector, such as concept drift detector 150 in FIG. 1 and concept drift detection 330 in FIG. 3, may decrease when the process of values of a feature during the time unit is nonstationary and the subtype is known.

According to some embodiments of the present disclosure, the performance of the concept drift detector, such as concept drift detector 150 in FIG. 1 and concept drift detection 330 in FIG. 3, may decrease when the process of values of a feature during the time unit is nonstationary and the subtype is unknown.

According to some embodiments of the present disclosure, the performance of the concept drift detector, such as concept drift detector 150 in FIG. 1 and concept drift detection 330 in FIG. 3, may be the worst when the process of values of a feature during the time unit is unknown and the subtype is unknown.

FIGS. 7A-7B show graphs of stationary and nonstationary processes.

According to some embodiments of the present disclosure, graph 710 shows a precise detection of a concept drift start and precise detection of its end. The preciseness is within exact place and exact time a point in time or a period before the drift and the point in time or a period before the end of the drift.

According to some embodiments of the present disclosure, graph 720 shows that there is no drift assuming the amplitude of the fluctuation is insignificant in its magnitude and time period. The preciseness and accuracy of the concept drift detector in this case is that it does not send false drift-alerts to the ML model.

According to some embodiments of the present disclosure, graph 730 shows a complexity of an unstable behavior of the financial data and its changing statistics over time. However, assuming that intervals 1 and 2 are equal in time, i.e., duration, and intervals 3, 4, 5 are equal in time i.e., duration, and in its magnitude, a cyclic behavior that repeats itself every period may be detected.

Consequently, in a global scale there is no drift, because the pattern repeats itself and that is the data that a data-analysis system may provide to the concept drift detector. However, if the data may not be provided to the concept drift detector, and only a local scale look may be taken, then, each up and down may be considered as a drift. Hence, the concept drift detector may behave according to the information it has about the data. If the concept drift detector is not provided with the entire picture, that is a process type and subtype then, it will send drift-alerts to the ML model every single period, which may result in an inefficient ML model behavior since it may redundantly update itself every short period.

If a concept drift detector is not provided with a process type and subtype, it might send drift-alerts, that will make the ML model update itself incorrectly. That means it will start to update itself not according to the best algorithm, or at wrong time. The notion of drift or change is relative. Looking at a process with a resolution of millisecond, a behavior of a nonstationary process with ups and downs may be detected in comparison to an hourly view.

According to some embodiments of the present disclosure, graph 740 depicts an obvious trend of the data that increases all the time from the moment it started. If this period is defined as indefinite, then a concept drift detector that may be provided with the process type and subtype should interpret it as no drift due to the deterministic trend. However, if the concept drift detector interprets as an interval, then it will send an alert about the drift, its place e.g., value and time to the ML model without sending drift-alert about the end of the drift.

According to some embodiments of the present disclosure, the disadvantage of a process that is shown in graph 740, is for example, given a predefined scope of period e.g., hourly, then a concept drift detector may detect a start of a drift and might wait till the hour ends. Once the hour ends it may send a drift-alert about end of the drift, and then almost immediately sends alert about the start of the drift again. Waits an hour and then sends alert about end of the drift etc. If period equals 1 sec, all that will repeat itself every second.

Graph 750 shows a nonstationary process having a fluctuate mean and a constant variance (time invariant). The calculated mean for the zigzag curve, which is the process e.g., every 10 points on the curve, is changing between each 10 points i.e., a window 10 points. The calculated variance, e.g., every 10 points shows that the variance is still the same from window to window. Graph 760 shows a stationary process having a constant mean (time invariant) and a constant variance (time invariant). Graph 770 shows a nonstationary process having a constant mean (time invariant) and a nonstationary variance.

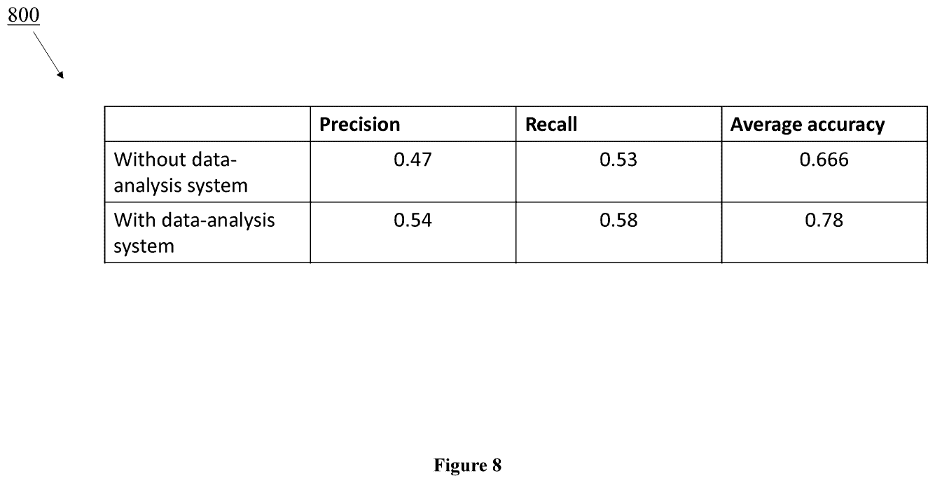

FIG. 8 shows a table 800 of evaluation results and comparisons, in accordance with some embodiments of the present disclosure.

According to some embodiments of the present disclosure, table 800 represents evaluation metrics for an ML model performance with concept drift in two cases: without an advanced data analysis unit, such as advanced data analysis unit 140 in FIG. 1 and with the advanced data analysis unit.

The evaluation metrics are precision, recall and average accuracy. The precision metric is an indicator of a machine learning model's performance. It is the quality of a positive prediction made by the ML model. The precision refers to the number of true positives divided by the total number of positive predictions, i.e., the number of true positives plus the number of false positives.

The recall is a metric that measures the ability of a ML model to find all the relevant cases within a data set. Mathematically, a recall is defined as the number of true positives divided by the number of true positives plus the number of false negatives. The ability of a classification model to identify only the relevant data points.

According to some embodiments of the current disclosure, table 800 shows that the ML model that is being operated in a system with the advanced data analysis unit part outperforms the ML model that utilizes only concept drift detector without having an advanced data analysis, such as the advanced data analysis unit 140 in FIG. 1.

The average accuracy may be calculated by the number of correct predictions divided by the total number of predictions.

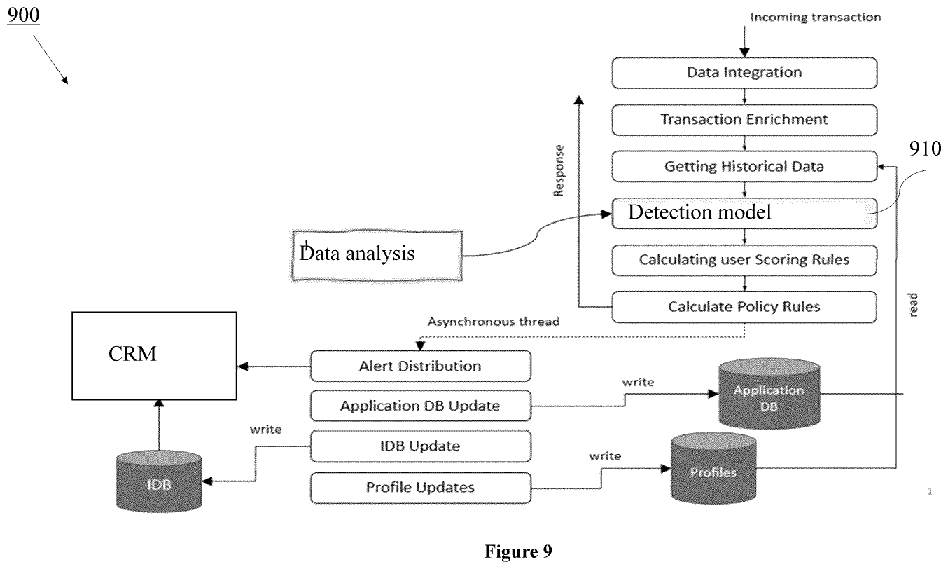

FIG. 9 is a high-level process flow diagram 900, in accordance with some embodiments of the present disclosure.

According to some embodiments of the current disclosure, a fraud-detection ML model, such as ML model 170 in FIG. 1 in a finance-system in production-environment, may be deployed in a detection model, such as detection model 910.

According to some embodiments of the current disclosure, system 900 includes incoming financial transactions into a data integration component which is operating an initial preprocess of the data. Transaction enrichments is the process where preprocess of the transactions happen. The process of getting historical data synchronizes with new incoming transactions. It is followed by the detection model 910 after which, each transaction gets its risk score.

A policy calculation treats the transactions having a high-risk score i.e., suspicious scores and routes it accordingly. Profiles contain aggregated financial transactions according time period. Profile updates synchronize according to new created or incoming transactions. Customer Relationship Management (CRM) is a system where risk score management is operated: investigation, monitoring, sending alerts, or marking as no risk.

According to some embodiments of the current disclosure, Investigation Data Base (IDB) system is used when research transactional data and policy rules resulting for investigation purposes. It analyzes historical cases and alert data.

According to some embodiments of the current disclosure, analysts can define calculated variables using a comprehensive context, such as the current transaction, the history of the main entity associated with the transaction, the built-in models result etc. These variables can be used to create new indicative features. The variables can be exported to the detection log, stored in IDB and exposed to users in user analytics contexts.

According to some embodiments of the current disclosure, financial transactions that satisfy certain criteria may indicate occurrence of events that may be interesting for the analyst. The analyst can define events the system identifies and profiles when processing the transaction. This data can be used to create complementary indicative features (using the custom indicative features mechanism or SMO). For example, the analyst can define an event that says: amount>$100,000. The system profiles aggregations for all transactions that trigger this event, e.g., first time it happened for the transaction party etc.

According to some embodiments of the current disclosure, Structured Model Overlay (SMO) is a framework in which the analyst gets all outputs of built-in and custom analytics as input to be used to enhance the detection results with issues and set the risk score of the transaction.

According to some embodiments of the current disclosure, analytics logic is implemented in two phases, where only a subset of the transactions goes through the second phase, as determined by a filter. The filter may be a business activity.

According to some embodiments of the current disclosure, the detection log contains transactions enriched with analytics data such as indicative features results and variables. The Analyst has the ability to configure which data should be exported to the log and use it for both pre-production and post-production tuning.

According to some embodiments of the current disclosure, the detection flow for transactions consists of multiple steps, data fetch for detection, e.g., detection period sets and profile data for the entity, variable calculations, analytics models consisting of different indicative feature instances, and SMO.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for analyzing financial data to improve performance of a concept drift detector that is providing alerts of drift to an update component of a machine learning model for fraud prediction and detection, said computerized-method comprising:
retrieving a time-series data of financial transactions having one or more features, during a time unit from a time-series financial transactions database;
for each feature of the one or more features, detecting a process of values of the feature during the time unit to determine a type of the process;
when the type of the process of a feature of the one or more features is determined as nonstationary, determining a subtype thereof and checking if the process is feasible for rectification to a stationary process;
when the process is feasible for rectification, operating a rectification module to:
(i) rectify the nonstationary process to a stationary process, and
(ii) determine the process as stationary;
when the type of the process is determined as stationary, determining a subtype thereof and when the type of the process is determined as nonstationary and the process is not feasible for rectification or when the type of the process is determined as stationary, then, forwarding the retrieved time-series data of financial transactions, the type of the process and the determined subtype to the concept drift detector and an identification of start time and end time of a drift during the time unit;
wherein the concept drift detector analyses the time-series data of financial transactions, the type of the process and the determined subtype to detect a drift therein and when a drift is detected the concept drift detector sends a drift-alert to an update component of the machine learning model via an update component, thereby improving machine learning model updates of itself according to the drift-alert, increasing accuracy of fraud predictions of the machine learning model and providing a memory efficient method.

2. The computerized-method of claim 1, wherein the detecting of the process of values of the feature during the time unit to determine the type of the process as stationary is performed by a first-test and the detecting of the process of values of the feature during the time unit to determine the type of the process as nonstationary is performed by a second-test.

3. The computerized-method of claim 2, wherein the first-test is selected from at least one of: (i) Kwiatkowski-Phillips-Schmidt-Shin (KPSS); (ii) other tests, and wherein the second-test is selected from at least one of: (i) Augmented Dickey Fuller (ADF); (ii) other tests.

4. The computerized-method of claim 1, wherein a stationary type of process is determined from at least one of: (i) strict stationary; (ii) 1^{st} order stationary; (iii) 2^{nd} order stationary.

5. The computerized-method of claim 1, wherein a nonstationary type of process is determined from at least one of: (i) deterministic trend; (ii) random walk; (iii) stochastic deterministic trend.

6. The computerized-method of claim 1, wherein the machine learning model is supervised or unsupervised.

7. The computerized-method of claim 1, wherein a drift-alert to the update component of the machine learning model includes: (i) start time and end time of the drift; and (ii) type and subtype of the process.

8. The computerized-method of claim 1, wherein the concept drift detector is using one or more preconfigured algorithms.

9. The computerized-method of claim 4, wherein the type of the process is determined as stationary when a process of values of the feature during the time unit has a constant mean or having an amplitude that neither increases nor decreases across the time-series data of the financial transactions.

10. The computerized-method of claim 5, wherein the type of the process is determined as nonstationary when a process of values of the feature during the time unit hasn't a constant mean or having an amplitude that neither increases nor decreases across the time-series data of financial transactions.

11. The computerized-method of claim 9, wherein a subtype of a stationary process is determined as: (i) strict stationary when all statistic parameters are constant; (ii) 1^{st} order stationary when a calculated mean of the values of the feature during the time unit is constant and other statistic parameters vary; (iii) 2^{nd} order stationary when a calculated mean of the values of the feature during the time unit is constant, variance and autocovariance constant and all other statistic parameters vary.

12. The computerized-method of claim 1, wherein the identification of start time and end time of a drift during the time unit is identified by a concept drift detection algorithm.

13. A data-analysis system for analyzing financial data to improve performance of a concept drift detector that is providing alerts of drift to an update component of a machine learning model for fraud prediction, the data-analysis system comprising:
a time-series financial transactions database;
a memory to store the time-series financial transactions database, and
one or more processors, said one or more processors are configured to:
retrieve a time-series data of financial transactions having one or more features, during a time unit from a time-series financial transactions database;
for each feature of the one or more features, detect a process of values of the feature during the time unit to determine a type of the process;
when the type of the process of a feature of the one or more features is determined as nonstationary, determine a subtype thereof and checking if the process is feasible for rectification to a stationary process;
when the process is feasible for rectification, operate a rectification module to:
(i) rectify the nonstationary process to a stationary process, and
(ii) determine the process as stationary;
when the type of the process is determined as stationary, determine a subtype thereof, and when the type of the process is determined as nonstationary and is not feasible for rectification or when the type of the process is determined as stationary, then, forward the retrieved time-series data of financial transactions, the type of the process and the determined subtype to the concept drift detector and an identification of start time and end time of a drift during the time unit,
wherein the concept drift detector analyses the time-series data of financial transactions, the type of the process and the determined subtype to detect a drift therein and when a drift is detected the concept drift detector sends a drift-alert to an update component of the machine learning model, thereby improving updates of the machine learning model according to the drift-alert, increasing accuracy of fraud predictions of the machine learning model and providing a memory efficient method.
